(19) United States
(12) Patent Application Publication
(10) Pub. No.: US 2002/0112688 A1
(43) Pub. Date: Aug. 22, 2002

(54) Neutral safety switch

(76) Inventors: Joseph P. Fariz, Nashua, NH (US); Gabor L. Szakacs, Nashua, NH (US)

Correspondence Address: BOURQUE & ASSOCIATES, P.A., 835 Hanover Street, Suite 301, Manchester, NH, 03104, US

(21) Appl. No.: 10/038,280

(22) Filed: Jan. 4, 2002

Related U.S. Application Data
(60) Provisional application No. 60/259,996, filed on Jan. 5, 2001.

(51) Int. Cl. F02N 11/08

(52) U.S. Cl. 123/179.2; 307/10.6; 477/183

(57) ABSTRACT

A neutral safety switch (NSS) is described for use with a remote engine starting system. The NSS may be attached to each of an emergency brake on, door open, engine running and motion sensor. By sensing the state of the sensor inputs, the NSS determines that the emergency brake has been set, that the vehicle transmission is in neutral and that the driver and passengers have left the vehicle, and if these conditions are not met, disables the remote starting system. The NSS may be used with automatic or manual transmission vehicles.

### REFERENCE TO RELATED APPLICATIONS

This application claims priority from a provisional application filed with the Patent And Trademark Office on Jan. 5, 2001, assigned application Ser. No. 60/259,996 and which is incorporated herein by reference.

### TECHNICAL FIELD

The present invention relates to motor vehicles, and more particularly, remote starters for motor vehicle engines.

### BACKGROUND INFORMATION

Remote starters are known, and used to enable a driver to start a vehicle remotely, for example so as to have it warmed on a cold day. Such devices are typically safely useable only on vehicles which cannot be started unless the vehicle is in neutral. Otherwise, when started remotely, the vehicle might go into motion with no driver in control of the vehicle.

Other circumstances can exist which would make it inadvisable to enable remote starting of a vehicle. For example, if a passenger were in the vehicle, it could be dangerous to start the vehicle if the passenger were a child who might accidentally or playfully put the car into gear. If the emergency brake were not set, it could be dangerous to start the vehicle. If the vehicle's engine were already running, engaging the starter remotely could damage the starting motor.

Motor vehicles with standard shifts have historically been unsuitable to fit with safe remote starting systems because of the difficulty of determining if the vehicle transmission is in neutral as a condition of actuating the remote starter.

### SUMMARY

In one embodiment, a neutral safety switch (NSS) is provided having inputs connectable to one or more of a door-open sensor, an engine-on sensor and an emergency brake sensor, and also a remote starter controller output having an enable and a disable state which is connectable to a remote starter motor controller. Based upon sensing the states of one or more of the sensors, the remote starter controller output is set into the enable or disable state. While the NSS remote starter controller output is in the disabled state, the NSS is in safe mode.

In another embodiment, the NSS also has an input connectable to a motion sensor, the sensor intended to be mounted on the interior (passenger) section of the motor vehicle so as to be able to detect motion of a passenger. In yet another embodiment, the door-open sensor and/or the engine on sensor are sampled over an interval to detect a change in state, indicating that either the door has gone from a closed to open condition or an open to closed condition, or that the engine has gone from an on condition to an off condition. In yet another embodiment, one or more of the door-open sensor and the emergency brake on sensor are monitored to indicate whether the door has opened, or the emergency brake has been released, and if so, the NSS is set into safety mode.

In a further embodiment, the NSS has a second output chaving an enable and a disable state, connectable to a motor vehicle ignition controller.

In another embodiment, invention includes a method utilizing an NSS connected to one or more sensors to sense if the emergency brake is on, to sense if the vehicle door opens (and closes) and to sense if the engine is on or off. In still another embodiment, the method includes sensing a motion sensor input to determine if a passenger is in the vehicle. Based upon the acts of sensing the state of the sensors, the remote starter controller output of the NSS is set to the enable or disable state.

### BRIEF DESCRIPTION OF THE DRAWINGS

These and other features and advantages of the present invention will be better understood by reading the following detailed description, taken together with the drawings wherein:

FIG. 1 is a block diagram of a neutral safety switch system.

FIG. 2 is a flow chart of a neutral safety switch logical operation.

### DETAILED DESCRIPTION

A neutral safety switch (NSS) is described which may be beneficially used on either manual or automatic transmission motor vehicles for use with a remote starter system. The NSS senses that the emergency brake has been set, that the driver has opened and closed the door to the vehicle (and presumably left the vehicle) and that the engine was running at the time of exit (indicating that the remote starter system was in a “stop and go” mode whereby the vehicle engine may be left running with the key removed from the ignition) and then turn off the engine, and await remote starting. If the door is subsequently opened (indicating that the driver has returned to the vehicle), the NSS enters a safety mode, disabling the remote starter system. If the emergency brake should be released for any reason, the NSS also enters into the safety mode. Optionally, the NSS may be used with a motion sensor mounted to sense motion within the interior (passenger) portion of the motor vehicle, and if motion is sensed, enter the safety mode.

The NSS may optionally be used with a motion sensor, which, if it senses motion (for example, if a passenger is in the vehicle) causes the NSS to enter the safety mode.

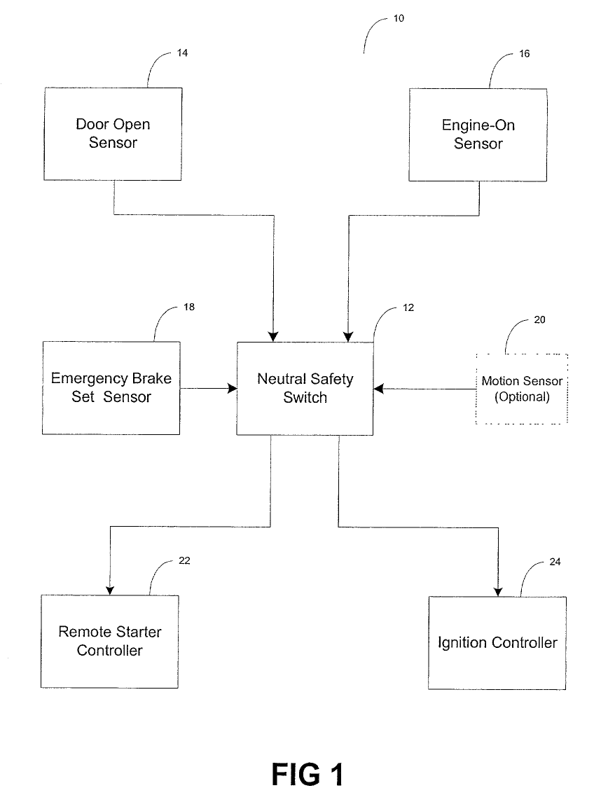

FIG. 1 shows a block diagram 10 of an NSS 12 in a remote vehicle engine starting system. The NSS may be fitted with one or more sensor inputs. In the embodiment described below, The NSS has three sensor inputs: a door-open sensor 12, an engine-on sensor 14, and an emergency brake set sensor 18. The NSS may also have a motion sensor 20 input.

The NSS 12 is connected to a door-open sensor 14 which may be implemented in any convenient way, such as a conventional electrical switch mounted on the door of a vehicle such that when the door is opened, causes the switch to change from on to off or vice versa. Other types of sensors may be used to the same effect, such as, for example, magnetic reed switches mounted on the vehicle so as to respond to a magnet attached to the door. Alternatively, a motion sensor may be utilized which is mounted so as to detect motion in the interior (passenger) portion of the motor vehicle.

The NSS is connected to an engine-on sensor 16. In one embodiment, the engine-on sensor provides pulses from a tachometer to the NSS which indicate that the engine is running. In another embodiment, the engine-on sensor provides pulses from a fuel injector which indicates that fuel is flowing to the engine, and hence the engine is on. In one embodiment, the NSS will sense that three pulses have been received within one second as an indication that the engine is running. Other types of sensors and methods of interpretation may be used beneficially to the same effect, such as, for example, a sensor responsive to a magnet mounted on a flywheel such that an electrical pulse is generated on each turn of the flywheel.

The NSS is connected to an emergency brake sensor, which indicates if the emergency brake has been set. Such a sensor may be an electrical switch mounted in a manner so as to change from off to on (or on to off) based upon the location of the emergency brake lever. Other forms and types of sensors may be beneficially utilized.

Optionally, the NSS may also be connected to a motion sensor 20, mounted so as to detect motion in the interior of the motor vehicle.

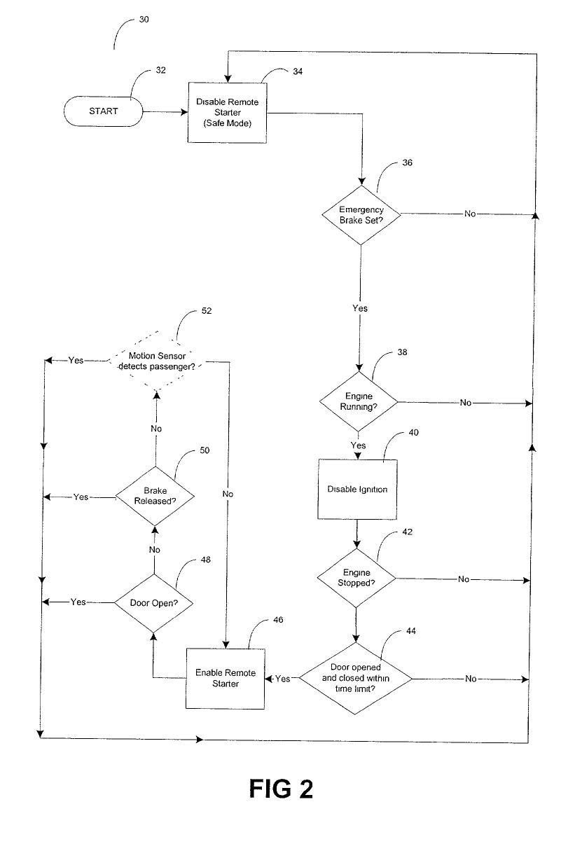

FIG. 2 shows a flow chart of one embodiment of an NSS logic flow 30. Beginning at the start 32, the NSS enters a safety mode 34 wherein the remote starter is disabled. Unless various conditions (described below) are met, the NSS always returns to the safety mode 34.

The NSS senses whether the emergency brake has been set 36. If not, NSS stays in safety mode 34.

If the brake has been set, the NSS senses if the engine is running 38, indicating that the transmission is in neutral. If the engine is not running, the remote starter has not been set into stop and go mode, and the NSS returns to safety mode 34. If the engine is running, the NSS then disables 40 the ignition controller, and checks to see that the engine has stopped 42. If the engine does not stop within a set time, the NSS returns to safety mode 34.

In one embodiment, the ignition controller is wired so as to be in parallel with the ignition key switch. Thus, if the key is in the ignition, disabling the ignition controller will not turn off the engine. Thus, if the key remains in the ignition, the NSS will stay in safety mode.

If the engine has stopped, the door open sensor is sensed. The NSS waits for a set period of time (five minutes in one embodiment) to see if the door has opened and closed (indicating that the driver has left the vehicle). If the door is not opened and closed within the set period, the NSS returns to the safety mode 34.

If the foregoing conditions have been met, the NSS enables the remote starting system. The NSS continues to monitor the door open sensor input 48 and the brake released sensor input 50. If either the door is opened or the emergency brake released, the NSS enters safety mode 34, disabling the remote starter.

If provided with a motion sensor, NSS will also enter safety mode if motion is detected 52 in the interior of the motor vehicle. Accordingly, if the driver has not, in fact, exited the vehicle, or if a passenger remains in the vehicle, the remote starter is disabled.

The NSS′ remote starter controller output may be wired in series with the remote starter system power feed to the motor vehicle's starter motor, so as to effectively enable and disable the remote starter system from providing power to the starter motor. Other configurations accomplishing the same result may be utilized, such as, for example, controlling an enable input provided on a remote starter system.

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM and flash memory devices. Any of the foregoing can be supplemented by, or incorporated in, ASICs (application-specific integrated circuits).

Modifications and substitutions by one of ordinary skill in the art are considered to be within the scope of the present invention, which is not to be limited except by the following claims. For example, the steps of the invention can be performed in a different order and still achieve desirable results.

What is claimed is:

1. A neutral safety switch comprising:
an electrical circuit having control logic, having at least one sensor input connectable to a sensor chosen from the group consisting of a door-open sensor, an engine-on sensor and an emergency brake sensor, and having a remote starter controller output having an enable state and a disable state, and which is connectable to a remote starter motor controller; and
wherein the control logic is configured to sense the state of the at least one sensor input, and, based upon the sensing, set the state of the remote starter controller output to one of said enable and disable states.

2. The neutral safety switch of claim 1 wherein the electrical circuit comprises at least three sensor inputs, and wherein the control logic is further configured to sense the state of each of the at least three sensor inputs, and based upon the sensing, set the state of the remote starter controller output to one of said enable and disable states.

3. The neutral safety switch of claim 2 wherein the at least three sensor inputs comprise a door-open sensor input, an engine-on sensor input and an emergency brake sensor input.

4. The neutral safety switch of claim 3 wherein, based upon the sensing, the control logic is configured to set the state of the remote starter controller output to one of said enable and disable states.

5. The neutral safety switch of claim 3 wherein the control logic is further configured to sense the state of the engine-on sensor input at a first time and at a second time, and based on the sensing, setting the state of the remote starter controller output to one of said enable and disable states.

6. The neutral safety switch of claim 3 wherein the control logic is further configured to sense the state of the door open sensor input at a third time and at a fourth time, and based on the sensing, setting the state of the remote starter controller output to one of said enable and disable states.

7. The neutral safety switch of claim 3 wherein the control logic is further configured to sense the state of the emergency brake sensor, and based on the sensing, setting the state of the remote starter controller output to one of said enable and disable states.

8. The neutral safety switch of claim 3 further comprising a second electrical output having an enable and a disable state, and which is connectable to a motor vehicle ignition control.

9. The neutral safety switch of claim 8 wherein the control logic is further configured, based upon the sensing of the engine-on sensor, to set the state of the remote starter controller output to one of said enable and disable states.

10. The neutral safety switch of claim 9 wherein the control logic is further configured to sense the state of the engine-on sensor after having set the second electrical output to the disable state, and, based upon the sensing, set the state of the remote starter controller output.

11. A method comprising:
providing a neutral safety switch having at least a door-open sensor input, an emergency brake sensor input and an engine-on sensor input, the neutral safety switch further comprising an ignition control output having an enable state and a disable state and which is connectable to a motor vehicle ignition controller, the neutral safety switch further comprising a remote starter motor controller output having an enable state and a disable state, and which is connectable to a remote starter motor controller;
sensing the emergency brake sensor input;
sensing the door open sensor input a first time;
sensing the door-open sensor input a second time;
sensing the engine-on sensor input a first time, and, based upon the sensing, changing the ignition control output state;
sensing the engine-on sensor input a second time;
based upon the sensing, setting the state of the remote starter motor controller output.

12. The method of claim 11 further comprising after the setting step sensing the emergency brake sensor input, and based upon the sensing, setting the remote starter controller output to the disable state.

13. The method of claim 11 further comprising after the setting act sensing the door-open sensor input, and, based upon the sensing, setting the remote starter controller output to the disable state.

14. The method of claim 11 wherein the neutral safety switch further comprises a motion sensor input, and further comprising the act of sensing the motion sensor input, and based upon the sensing, setting the remote starter controller output to the disable state.
